(19) United States
(12) Patent Application Publication
(10) Pub. No.: US 2025/0371775 A1
(43) Pub. Date: Dec. 4, 2025

(54) INFORMATION PROCESSING DEVICE, INFORMATION PROCESSING METHOD, AND RECORDING MEDIUM

(71) Applicant: SONY GROUP CORPORATION, TOKYO (JP)

(72) Inventor: RURI OYA, TOKYO (JP)

(21) Appl. No.: 18/876,740

(22) PCT Filed: Jun. 12, 2023
(86) PCT No.: PCT/JP2023/021695

§ 371 Date: Dec. 19, 2024

(30) Foreign Application Priority Data
Jun. 28, 2022 (JP) 2022-103492

(51) Int. Cl. G06T 13/20; G06T 13/40; G10L 17/26

(52) U.S. Cl. CPC G06T 13/205; G06T 13/40; G10L 17/26

(57) ABSTRACT

The present technology relates to an information processing device, an information processing method, and a recording medium that are capable of generating a 3D avatar according to characteristics of a voice of a user.

An information processing device according to one aspect of the present technology acquires voice data of a user; calculates voice features based on a result of analyzing the voice data of the user; and generates a 3D avatar having an appearance according to at least one of a plurality of impression word scores calculated on the basis of the features. The present technology can be applied to processing of generating a 3D avatar.

### TECHNICAL FIELD

The present technology relates to an information processing device, an information processing method, and a recording medium, and more particularly to an information processing device, an information processing method, and a recording medium that are capable of generating a 3D avatar according to characteristics of the voice of a user.

### BACKGROUND ART

In a virtual space where a lot of people participate, such as the metaverse, communication between users takes place through avatars. Since each user communicates with other users while viewing their avatars, there is a growing demand for technology that can create an avatar unique to each user.

### CITATION LIST

### Patent Literature

### PTL 1

JP 2021-43841A

### SUMMARY

### Technical Problem

In order to create an avatar unique to a user, there are possible methods, such as asking a designer to create the avatar or allowing the user to select parts to create an avatar by the user. However, these methods involve time and financial costs.

There is another possible method, for example, automatically generating an avatar that reproduces the face of a user based on an image of the face of the user.

However, this method has the problem that it is difficult to reflect elements unique to the user in the avatar.

In addition, when an avatar is displayed as the alter-ego of a user and is made to speak using the voice of the user, there is a possibility that a mismatch will occur between the impression other users have of the voice of the user and the impression they have of the appearance of the avatar.

The present technology has been made in view of such circumstances, and makes it possible to generate a 3D avatar according to the voice of a user.

### Solution to Problem

An information processing device according to one aspect of the present technology includes: a voice acquisition unit that acquires voice data of a user; a voice analysis unit that calculates voice features based on a result of analyzing the voice data of the user; and a 3D avatar generation unit that generates a 3D avatar having an appearance according to at least one of a plurality of impression word scores calculated on the basis of the voice features.

In one aspect of the present technology, voice data of a user is acquired; voice features are calculated on the basis of a result of analyzing the voice data of the user; and a 3D avatar having an appearance according to at least one of a plurality of impression word scores calculated on the basis of the voice features is generated.

### BRIEF DESCRIPTION OF DRAWINGS

FIG. 1 is a diagram illustrating a flow of processing of generating a 3D avatar.

FIG. 2 illustrates an example of a UI when a mobile terminal receives the voice input from a user.

FIG. 3 illustrates an example of a UI when another 3D avatar is generated on the basis of the voice input from another user.

FIG. 4 is a block diagram illustrating a hardware configuration example of the mobile terminal.

FIG. 5 is a block diagram illustrating a functional configuration example of an information processing unit.

FIG. 6 illustrates examples of impression words constituting an impression word dataset.

FIG. 7 illustrates examples of appearance parameters used to generate a 3D avatar.

FIG. 8 is a flowchart related to a series of processing of generating a 3D avatar based on the voice of a user.

FIG. 9 illustrates an outline of processing of the present technology according to a modification example.

### DESCRIPTION OF EMBODIMENTS

An embodiment for implementing the present technology will be described below. The description will be made in the following order.
1. Outline of Present Technology
2. Configuration of Mobile Terminal 1
3. Operation of Mobile Terminal 1
4. Modification Examples

### 1. Outline of Present Technology

The present technology is a technology related to processing of generating a 3D avatar that is used as the alter-ego of a user in, for example, a virtual space.

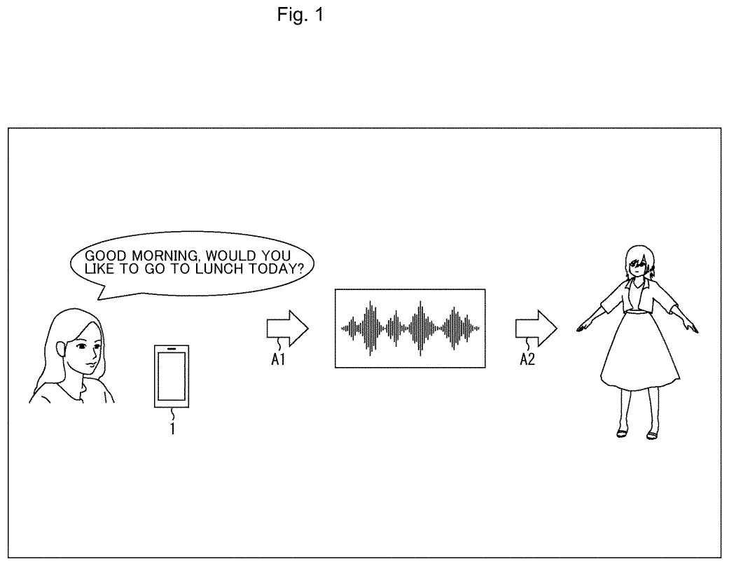

An outline of the processing of the present technology will be described below with reference to FIG. 1. FIG. 1 is a diagram illustrating a flow of the processing of generating a 3D avatar.

The state illustrated on the left side in FIG. 1 is a state in which a user is speaking into a mobile terminal 1. The speech/voice of the user is input to the mobile terminal 1 and used to generate a 3D avatar, as described below. In this way, the mobile terminal 1 is an information processing device that generates a 3D avatar according to the voice uttered by a user.

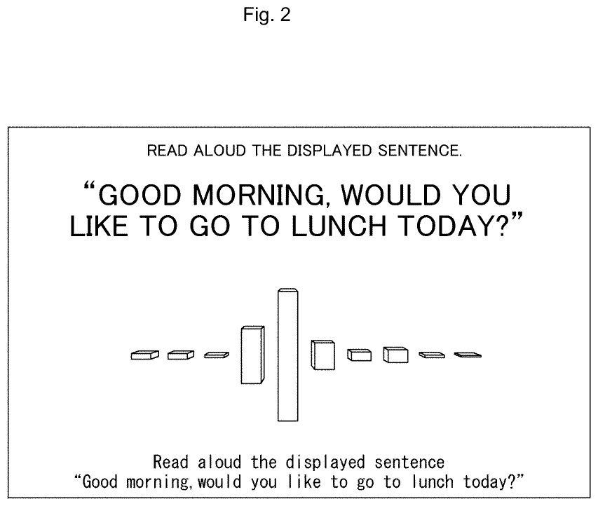

An example of a UI in the state on the left side in FIG. 1 will be described with reference to FIG. 2. FIG. 2 illustrates an example of a UI when the mobile terminal 1 receives a voice input from a user.

As illustrated in FIG. 2, a message “Read aloud the displayed sentence” is displayed at the top of a screen of the mobile terminal 1, and below that, a message “‘Good morning, would you like to go to lunch today?”’ is displayed.

In this way, the mobile terminal 1 requests the user to input a voice by displaying the content of a speech on the screen. The user looks at the message displayed on the screen and speaks into the mobile terminal 1 as shown in a speech bubble in FIG. 1. For example, a plurality of types of speech content are presented in sequence, and their respective voices are input to the mobile terminal 1.

Next, the state indicated next to an arrow A1 in FIG. 1 is a state in which the mobile terminal 1 is analyzing the voice of the user. By analyzing the voice of the user, voice features that represent the characteristics of the voice of the user are calculated. The voice features are a group of numerical values that indicate the levels of a plurality of items that represent the characteristics of the voice, such as the loudness (volume), degree of intonation, and pitch (frequency).

After calculating the voice features, the mobile terminal 1 calculates impression word scores based on the voice features. The impression word score is a numerical value indicating an impression that a voice may give to a person. A group of numerical values that indicate the levels of items as impression words, such as outgoing, active, and cooperative, which each represent an impression felt by a person, is calculated as impression word scores.

After calculating the impression word scores, the mobile terminal 1 converts impression word scores into appearance parameters. The mobile terminal 1 also generates a 3D avatar based on the appearance parameters obtained by converting the impression word scores.

More specifically, the mobile terminal 1 changes the base body of the 3D avatar, which is in a default appearance state, based on the appearance parameters, and generates a 3D avatar according to the voice of the user. A 3D model having a default appearance is prepared in the mobile terminal 1 as a 3D avatar to be transformed. For example, a 3D avatar is generated according to the voice of the user by moving, deforming, replacing, and adding each of the parts that make up the base body. The appearance parameters are information indicating the degrees of changes, such as movement, deformation, replacement, and addition, of each of the parts that make up the base body.

Next, the state indicated next to an arrow A2 in FIG. 1 is a state in which the 3D avatar obtained as the result of generation is displayed on the mobile terminal 1. By looking at the display on the mobile terminal 1, the user can check the result of generation of the 3D avatar according to the user's voice.

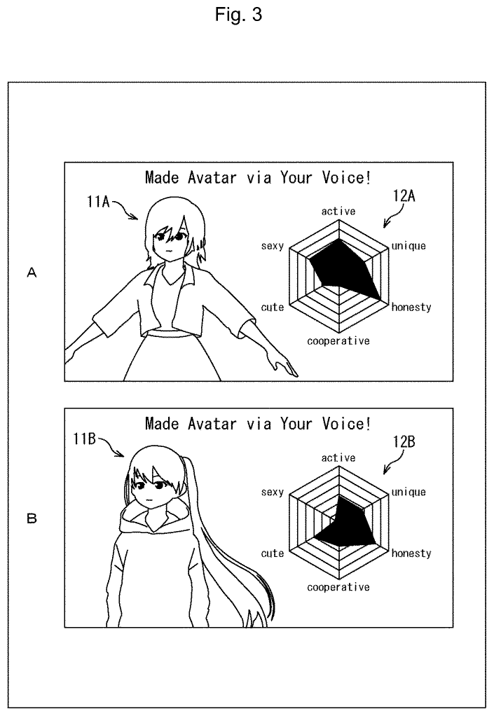

An example of a UI in the state indicated next to the arrow A2 in FIG. 1 will be described with reference to FIG. 3. FIG. 3 illustrates an example of a UI when the mobile terminal 1 displays the result of generation of a 3D avatar. In FIG. 3, A and B illustrate examples of UIs when different 3D avatars are generated on the basis of voice inputs from different users, respectively.

As illustrated in A and B of FIG. 3, avatars 11A and 11B, which are 3D avatars generated on the basis of different voice inputs to the mobile terminal 1, are displayed as the results of generation of 3D avatars. The avatar 11A and the avatar 11B are 3D avatars having different appearances, generated using different appearance parameters.

A graph 12A is displayed to the right of the avatar 11A, and a graph 12B is displayed to the right of the avatar 11B. The graph 12A and the graph 12B are graphs that represent at least some of the plurality of impression word scores used to generate the respective 3D avatars. In the example of FIG. 3, radar charts that each indicate the scores of six impression words: active, sexy, cute, cooperative, honesty, and unique, are displayed as the graphs 12A and 12B.

In the graph 12A in A of FIG. 3, honesty has the highest score, and active has the second highest score. And, cooperative has the lowest score.

On the other hand, in the graph 12B in B of FIG. 3, as in the case of A of FIG. 3, honesty has the highest score, while cute has the second highest score. And, sexy had the lowest score.

Such a screen being displayed allows the user to check the results of calculating the impression word scores and the result of generating a 3D avatar in response to the voice input. In addition, simply by speaking into the mobile terminal 1, the user can generate a 3D avatar in which the characteristics of the user's voice are reflected.

The data of the 3D avatar generated in the mobile terminal 1 is provided to the user and used in a virtual space service provided by a certain operator, for example. The user can use the 3D avatar generated by the mobile terminal 1 to communicate with other users in a virtual space.

### 2. Configuration of Mobile Terminal 1

### Configuration of Hardware

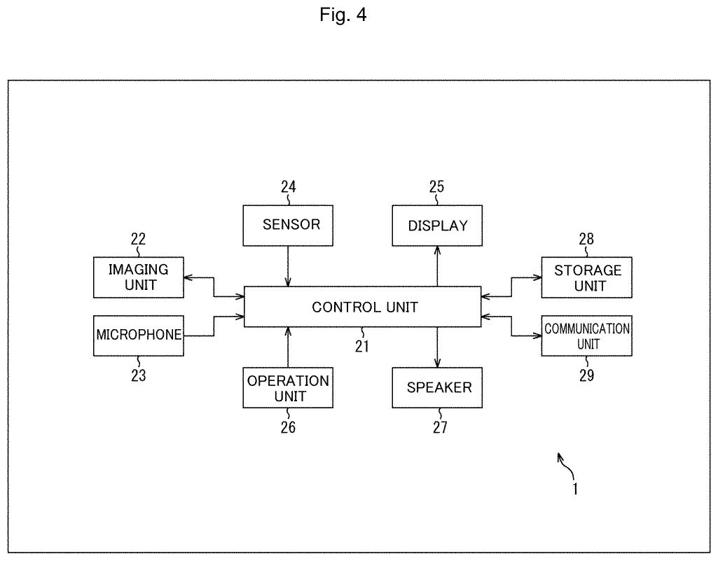

FIG. 4 is a block diagram illustrating a hardware configuration example of the mobile terminal 1.

The mobile terminal 1 is configured of a control unit 21 connected to an imaging unit 22, a microphone 23, a sensor 24, a display 25, an operation unit 26, a speaker 27, a storage unit 28, and a communication unit 29.

The control unit 21 includes a CPU, a ROM, and a RAM. The control unit 21 executes a predetermined program and controls the overall operation of the mobile terminal 1 in response to user operations and the like.

The imaging unit 22 includes a lens, an imaging element, and the like, and captures an image under the control of the control unit 21. The imaging unit 22 outputs image data obtained by capturing an image to the control unit 21.

The microphone 23 supplies collected voice data to the control unit 21. The voice uttered by the user is collected by the microphone 23 and supplied to the control unit 21 as voice data.

The sensor 24 includes a GPS sensor (positioning sensor), an acceleration sensor, a gyro sensor, and the like, and outputs data acquired by each sensor to the control unit 21.

The display 25 includes a liquid crystal display (LCD) and the like, and displays various types of information such as the result of generating a 3D avatar under the control of the control unit 21. For example, as described above, a graph of impression word scores that represent a result of analyzing the voice of the user and a generated 3D avatar are displayed.

The operation unit 26 includes operation buttons, a touch panel, and the like, which are provided on the surface of a housing of the mobile terminal 1. The operation unit 26 outputs information indicating the content of user's operations to the control unit 21.

The speaker 27 outputs a sound such as a voice based on data supplied from the control unit 21.

The storage unit 28 includes a flash memory or a memory card inserted into a card slot provided in the housing. The storage unit 28 stores various types of data such as the 3D avatar model data supplied from the control unit 21.

The communication unit 29 performs wireless or wired communication with an external device.

### Functional Configuration

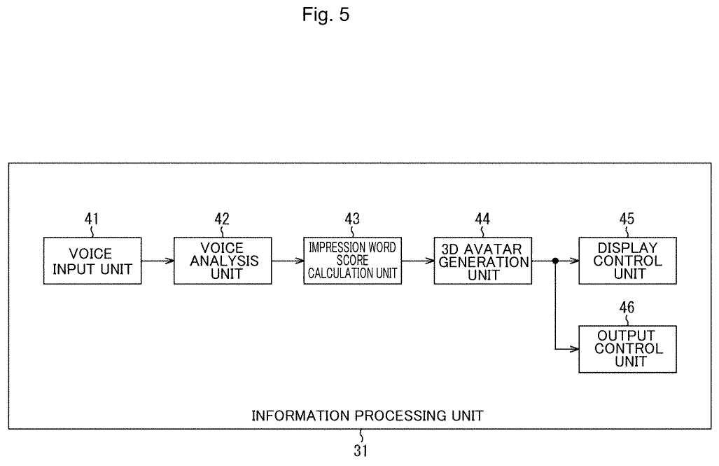

FIG. 5 is a block diagram illustrating a functional configuration example of an information processing unit 31 realized by the mobile terminal 1.

The information processing unit 31 includes a voice input unit 41, a voice analysis unit 42, an impression word score calculation unit 43, a 3D avatar generation unit 44, a display control unit 45, and an output control unit 46. The CPU included in the control unit 21 executes a program to implement each of the functional units in FIG. 5.

The voice input unit 41 acquires voice data, which is data of the voice of the user collected by the microphone 23. The voice input unit 41 functions as a voice acquisition unit that acquires voice data of the user.

The voice of the user to be acquired by the voice input unit 41 may be a voice in which the user speaks a predetermined sentence as described above, or a voice freely spoken by the user. The voice of the user may be a voice recorded in real time or a voice recorded in advance. The voice data acquired by the voice input unit 41 is output to the voice analysis unit 42.

The voice analysis unit 42 analyzes the voice data acquired by the voice input unit 41 to detect voice features. The voice features include, for example, a fundamental frequency and a zero crossing rate. When the voice acquired by the voice input unit 41 is a voice freely spoken by the user, the voice analysis unit 42 may analyze the content of the speech using natural language processing and detect the analysis result as voice features. When natural language processing is used, various types of words used or selected by the user, such as words used by the user as the first person, may be detected as voice features. Information on the voice features detected by the voice analysis unit 42 is output to the impression word score calculation unit 43.

The impression word score calculation unit 43 calculates an impression word score for each of the impression words constituting an impression word data set prepared in advance, based on the voice features detected by the voice analysis unit 42. In the impression word score calculation unit 43, the impression word data set made up of the plurality of impression words is prepared in advance.

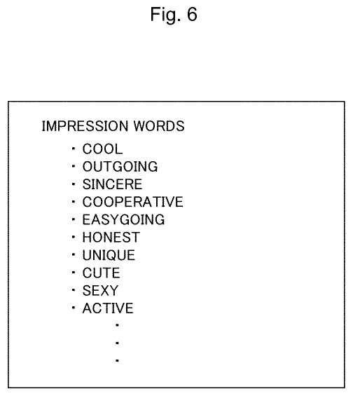

FIG. 6 illustrates examples of impression words constituting an impression word dataset.

As illustrated in FIG. 6, the impression words include “cool”, “outgoing”, “sincere”, “cooperative” (corresponding to cooperative in FIG. 3), “easygoing”, “honest” (corresponding to honesty in FIG. 3), “unique” (corresponding to unique in FIG. 3), “cute” (corresponding to cute in FIG. 3), “sexy” (corresponding to sexy in FIG. 3), and “active” (corresponding to active in FIG. 3). The impression words are not limited to the examples listed here, and may be any word that indicates an impression a person has.

An impression word score for each of the impression words as listed above is calculated on the basis of the voice features. The impression word score is calculated, for example, by using a conversion function that is linked to the corresponding impression word and is made up of voice features and weighting coefficients. The weighting coefficients used in the conversion function may be changed to reflect user preferences and the like. Information on the impression word scores calculated by the impression word score calculation unit 43 is output to the 3D avatar generation unit 44 in FIG. 5.

The 3D avatar generation unit 44 converts the impression word scores calculated by the impression word score calculation unit 43 into appearance parameters, and then generates a 3D avatar by moving, deforming, replacing, and adding each of the parts that make up a 3D model of the base body based on the appearance parameters. As described above, the appearance parameters are information indicating the degrees of changes for moving, deforming, replacing, or adding each of the parts that make up the base body.

The appearance parameters may include not only numerical values that indicate how the respective parts are to be, for example, moved, but also information for specifying the texture and material color to be used for each of the parts.

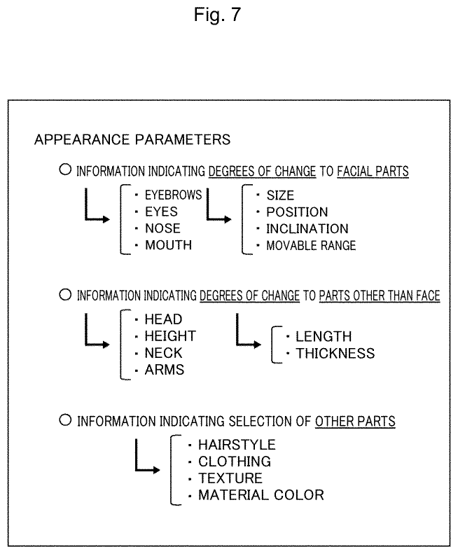

FIG. 7 illustrates examples of the appearance parameters used to generate a 3D avatar.

As illustrated in FIG. 7, the appearance parameters include three types of information: information indicating the degrees of change to facial parts, information indicating the degrees of change to parts other than the face, and information indicating the selection of other parts. Each of the three types of information will now be described.

The information indicating the degrees of change to the facial parts is information indicating amounts of change to the parts contained in the face of the base body, which is used when the 3D avatar generation unit 44 changes the 3D model of the base body to generate a 3D avatar.

Examples of the parts contained in the face include eyebrows, eyes, nose, and mouth. Examples of the amounts of change to each facial part include the amounts of change to the size, position, inclination, and movable range. The movable range is numerical values that indicate the movable range of each of the parts that make up the 3D avatar, used when the 3D avatar moves.

The appearance parameters that indicate the degrees of change to the facial parts specify the amounts of change to the size, position, inclination, and movable range of each of the facial parts, such as the eyes, that make up the base body. For example, when the default numerical value indicating the eye size of the base body is set to 1.0, the eye size of a 3D avatar with a high score for the impression word “cute” is specified as a numerical value of 1.5. For example, when the default numerical value indicating the mouth opening/closing range (movable range) of the base body is set to 0 to 1, the mouth opening/closing range of a 3D avatar with a high score for the impression word “cool” is specified as a numerical value of 0 to 0.5.

The information indicating the degrees of change to parts other than the face is information indicating amounts of change to the parts other than the face contained in the base body, which is used when the 3D avatar generation unit 44 changes the 3D model of the base body to generate a 3D avatar. Examples of the parts other than the face include head, torso, neck, and arms. Examples of the amounts of change to each part other than the face includes the amounts of change to the length and thickness.

The information indicating the selection of other parts is selection information for selecting parts other than the face, which is used when the 3D avatar generation unit 44 generates a 3D avatar by modifying the 3D model of the base body. The selection information specifies hairstyle, clothing, texture, material color, and the like. A hairstyle and clothing selected on the basis of the selection information from among a plurality of candidates prepared in advance, and textures and material colors also selected on the basis of the selection information are applied to the 3D model of the base body.

Appearance parameters that indicate the selection of other parts may be associated with each of the impression word scores. In this case, as an example, appearance parameters corresponding to the impression word having the highest impression word score numerical value among the impression word scores are selected. For example, when the impression word score of “active” is the highest, information for specifying “ponytail” as the hairstyle associated with the impression word “active” is selected.

How to calculate appearance parameters that indicate how the parts of the 3D model of the base body are to be moved, deformed, replaced, or added on the basis of each impression word score is defined by a function within the system. By applying each impression word score to the function, the 3D avatar generation unit 44 converts the impression word score into appearance parameters, and changes the 3D model of the base body based on the appearance parameters obtained by conversion.

The impression word score to be used as information on the source converted into appearance parameters may be the impression word score having the highest numerical value among the impression word scores, or may be an impression word score having a higher numerical value than a threshold numerical value. The impression word score having the lowest numerical value or an impression word score having a lower numerical value than a threshold numerical value may be used for conversion into appearance parameters.

The data of the 3D avatar generated by the 3D avatar generation unit 44 in the above-described manner is output to at least one of the display control unit 45 and the output control unit 46. Information on the impression word score used for conversion into appearance parameters is also output to the display control unit 45.

The display control unit 45 controls the display of the result of generating the 3D avatar on the display 25 based on the information supplied from the 3D avatar generation unit 44. The display control unit 45 also displays at least some of the impression word scores calculated as the result of analyzing the voice of the user, as a graph such as the graph 12A or 12B in FIG. 3, so that the user can check them.

The output control unit 46 outputs the data of the 3D avatar generated by the 3D avatar generation unit 44 in a format available to the user in virtual space services and the like. As the data of the 3D avatar, the model data of the 3D avatar itself may be output, or image data such as a moving image or a still image in which the 3D avatar appears may be output. The data of the 3D avatar output from the output control unit 46 is stored in the storage unit 28 or transmitted to an external device via the communication unit 29.

### 3. Operation of Mobile Terminal 1

An operation of the mobile terminal 1 having the above-described configuration will now be described.

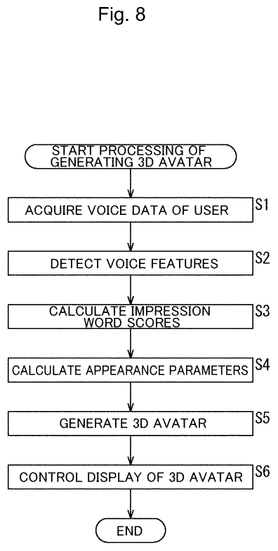

FIG. 8 is a flowchart related to a series of processing of generating a 3D avatar based on the voice of a user.

First, in step S1, the voice input unit 41 acquires voice data which is data of the voice of the user.

In step S2, the voice analysis unit 42 analyzes the voice acquired by the voice input unit 41 in step S1 to detect voice features.

In step S3, the impression word score calculation unit 43 calculates impression word scores based on the voice features detected by the voice analysis unit 42 in step S2.

In step S4, the 3D avatar generation unit 44 calculates appearance parameters based on the impression word scores calculated by the impression word score calculation unit 43 in step S3.

In step S5, the 3D avatar generation unit 44 changes the 3D model of the base body based on the appearance parameters calculated in step S4 to generate a 3D avatar according to the voice of the user.

In step S6, the display control unit 45 controls the display of the 3D avatar generated by the 3D avatar generation unit 44 in step S5.

By the processing as described above, for example, the generation of a 3D avatar as described below is achieved.

As a result of analyzing the voice of the user, when a high numerical value is detected as a numerical value indicating the degree of intonation from the standard deviation of the fundamental frequency of the voice, the numerical value of the impression word score for “outgoing” will be high. When the impression word score for “outgoing” is high, the numerical value of the appearance parameter that indicates the size of the mouth as a facial part will be high.

As a result, a 3D avatar having a larger mouth than that of the 3D model of the base body is generated as a 3D avatar according to the characteristics of the voice of the user, such as the voice having a high degree of intonation.

As a result of analyzing the voice of the user, when a low numerical value is detected as a numerical value indicating the speaking speed from the length of the speech and the length of pause, the numerical value of the impression word score for “easygoing” will be high. When the impression word score value for “easygoing” is high, the numerical value of the appearance parameter that indicates the inclination of the eyes as a facial part will be high.

As a result, a 3D avatar having droopy eyes, that is, eyes inclined more than those of the 3D model of the base body, is generated as a 3D avatar according to the characteristics of the voice of the user, such as the lengths of speech and pause of the voice.

As a result of analyzing the voice of the user, when a high numerical value is detected as a numerical value indicating the pitch of the voice from the height of the spectrum center of gravity of the voice, the numerical value of the impression word score for “cute” will be high. When the impression word score for “cute” is high, the numerical value of the appearance parameter that indicates the degree of roundness of the head contour as a part other than the face will be high.

As a result, a 3D avatar having a rounder head contour than that of the 3D model of the base body is generated as a 3D avatar according to the characteristics of the voice of the user, such as the voice having a high spectral center of gravity.

### 4. Modification Examples

### Modification Example 1

Although it has been described that all processing for generating a 3D avatar according to the voice of a user is performed in the mobile terminal 1, the above-described processing may also be performed by a server on a network.

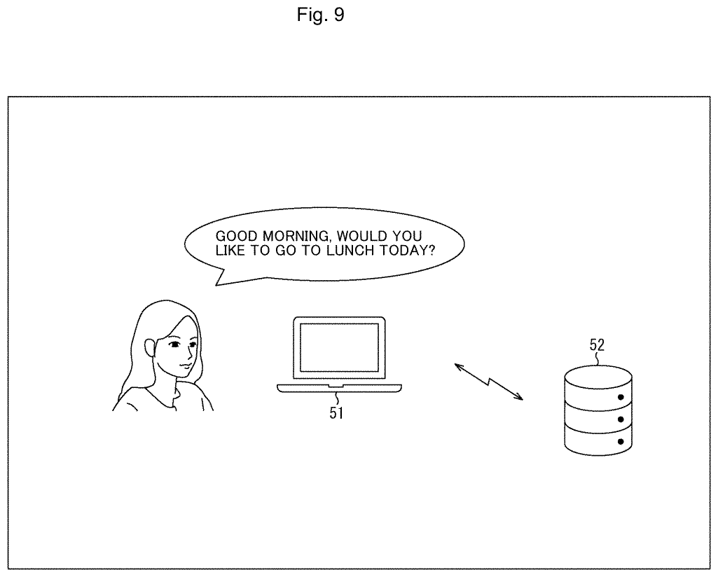

FIG. 9 illustrates an outline of processing of the present technology according to a modification example.

In the example of FIG. 9, the speech/voice of a user is input to a computer 51, such as a PC, used by the user. The functions of the information processing unit 31 in FIG. 5 are implemented in a server 52 by a CPU included in the server 52 executing a predetermined program. Various types of information are transmitted and received between the computer 51 and the server 52 via a network such as the Internet through wired or wireless communication.

The information processing unit 31 of the server 52 performs the same processing as that described with reference to FIG. 5 and others based on the voice of the user transmitted from the computer 51, to generate a 3D avatar according to the voice of the user. The 3D avatar generated by the 3D avatar generation unit 44 of the server 52 is displayed on a display of the computer 51 under the control of the display control unit 45.

In this way, the processing of generating a 3D avatar may be controlled by an external device. Although an example in which the processing is performed by the computer and the server has been described with reference to FIG. 9, a mobile terminal may be used instead of the computer so that the processing is performed by the mobile terminal and the server.

The model data of the 3D avatar generated by the server 52 may be transmitted to an external device such as the computer 51 in a downloadable format.

### Modification Example 2

The processing of the present technology may be incorporated into virtual space services such as games or the metaverse.

For example, when the user logs in to each virtual space service, a 3D avatar is generated according to the voice of the user. The user can obtain an avatar unique to the user without taking the time and effort to generate the avatar.

Furthermore, the processing of the present technology can also be applied for creation of animation works. For example, when a voice actor for a work has been decided in advance, the present technology can be used to generate a 3D avatar according to the voice of the voice actor.

### Modification Example 3

The 3D avatar generated by the present technology may be used as an agent.

The agent is, for example, an avatar of a company operator to be used when a customer and the operator have a conversation. The agent is displayed on a display of a device or the like prepared for the customer to make an inquiry to the company. The customer making an inquiry will speak to the agent displayed on the display.

In such cases, from a cost perspective, the same agent is often used for a plurality of operators. However, a discrepancy between an impression created from the agent's appearance and an impression created from the operator's voice can cause problems such as the customer being unable to concentrate on a guidance provided by the operator.

Using the present technology makes it possible to generate a 3D avatar according to the operator's voice at low cost. In addition, such problems can be solved by using a 3D avatar as an agent according to the operator's voice.

### Modification Example 4

As described with reference to FIG. 3, the user may be allowed to check the result of generating a 3D avatar together with the results of calculating impression word scores through a screen displayed on the display 25 of the mobile terminal 1. The user may be allowed to input numerical values for the impression word scores while viewing these results, so as to approach a 3D avatar having a desired appearance.

For example, when desired to make the 3D avatar obtained as the result of generation cuter, a numerical value for the impression word score “cute” higher than the calculated numerical value is input into the mobile terminal 1. The user's input to the operation unit 26 of the mobile terminal 1 is performed, for example, by specifying any position on the graph 12A and the graph 12B, which each display the results of calculating the impression word scores.

The impression word scores input by the user are supplied to the 3D avatar generation unit 44 of the information processing unit 31. The 3D avatar generation unit 44 calculates appearance parameters based on the impression word scores input by the user, and regenerates (modifies) a 3D avatar. The 3D avatar regenerated by the 3D avatar generation unit 44 is controlled by the display control unit 45 for display control on the screen.

In this way, the user can obtain a 3D avatar that closely matches the desired impression by simply inputting the impression word scores, without having to make detailed changes to the parts of the 3D avatar.

### Modification Example 5

In the present technology, a plurality of 3D models may be prepared for base bodies in advance.

For example, a plurality of 3D models of the base bodies are prepared that correspond to the respective impression words, such as “cute” and “outgoing”. The information processing unit 31 generates a 3D avatar using the base body associated with the impression word having the highest numerical value among the impression word scores calculated by analyzing the voice of the user.

This enables the information processing unit 31 to easily generate a 3D avatar that gives a significantly different impression while minimizing changes to the 3D avatar of the base body.

The user may be allowed to select a 3D model of a base body to be used to generate a 3D avatar from among a plurality of 3D models of base bodies. By selecting an impression word such as “cute” or “outgoing”, the user is allowed to select the 3D model of the base body associated with the selected impression word.

This makes it possible to easily generate a large number of characters when it is necessary to prepare a large number of characters with a unified world view, such as when an animation work is produced.

### Modification Example 6

As described above, the appearance parameters are associated with the impression words. One appearance parameter may be associated with one impression word, or one appearance parameter may be associated with a plurality of impression words. For example, the impression word associated with the appearance parameter “make mouth bigger” may be one impression word, “outgoing”, or may be two impression words, “outgoing” and “unique”.

Here, when one appearance parameter is associated with a plurality of impression words, it is assumed that the respective impression word score numerical values are different. In this case, the average value of the plurality of impression word scores may be used for conversion into appearance parameters, or only the impression word score having the highest numerical value may be used for conversion into appearance parameters.

For example, as described above, when the appearance parameter “make mouth bigger” is associated with the two impression words “outgoing” and “unique”, and the impression word score for “outgoing” is 2.0 and the impression word score for “unique” is 0.2, the average value of the two impression word scores, 1.1, may be used as an appearance parameter, and a transformation may be performed to increase the size of the mouth of the 3D model of the base body by 1.1 times. The impression word score for “outgoing” which has a larger numerical value may be given priority, and a numerical value of 2.0, which is the impression word score for “outgoing”, may be used as an appearance parameter, and a transformation may be performed to increase the size of the mouth of the 3D model of the base body by 2.0 times.

### Modification Example 7

The information processing unit 31 may calculate appearance parameters so that the parts making up the generated 3D avatar do not interfere with each other. For example, restrictions may be placed on the range of movement or the range of deformation of the parts so that the parts are not positioned so as to interfere with each other. Alternatively, processing such as shifting them to positions where they do not overlap may be added.

For example, when the 3D avatar takes a surprising action, the 3D avatar's eyes will be larger. In this case, if the range of movement of the eyes is large, the eyes will overlap with the eyebrows, making the 3D avatar look unnatural. Therefore, the movable range of the eyes may be narrowed so that they do not overlap with the eyebrows, or processing may be performed to lower the position of the eyes so that they do not overlap with the eyebrows.

### Others

The appearance parameters may be calculated using an inference model generated by machine learning. In this case, an inference model is prepared in the 3D avatar generation unit 44, in which the voice of a user is used as input and appearance parameters are used as output.

The above-described series of processing can also be performed by hardware or software. In a case in which the series of processing are performed by software, a program constituting the software are installed on a computer built into dedicated hardware, a general-purpose personal computer, or the like.

The installed program is provided by being recorded in a removable medium configured as an optical disc (a compact disc-read only memory (CD-ROM), a digital versatile disc (DVD), or the like), a semiconductor memory, or the like. The program may also be provided over a wired or wireless transmission medium such as a local area network, the Internet or digital broadcasting.

The program executed by the computer may be a program that performs a plurality of steps of processing in time series in the order described herein or may be a program that performs a plurality of steps of processing in parallel or at a necessary timing such as when a call is made.

The effects described herein are merely examples and are not limited, and other effects may be obtained.

The embodiments of the present technology are not limited to the above-described embodiments, and various changes can be made without departing from the scope and spirit of the present technology.

For example, the present technology can be configured as cloud computing in which one function is shared and processed together by a plurality of devices via a network.

In addition, each step described in the above flowcharts can be performed by one device or performed in a shared manner by a plurality of devices.

Furthermore, in a case in which one step includes a plurality of steps of processing, the plurality of steps of processing included in the one step can be performed by one device or performed in a shared manner by a plurality of devices.

### Combination Examples of Configurations

The present technology can also be configured as follows.

### 1

An information processing device including:
a voice acquisition unit that acquires voice data of a user;
a voice analysis unit that calculates voice features based on a result of analyzing the voice data of the user; and
a 3D avatar generation unit that generates a 3D avatar having an appearance according to at least one of a plurality of impression word scores calculated on the basis of the voice features.

### 2

The information processing device according to (1), wherein the 3D avatar generation unit generates the 3D avatar by changing a plurality of parts included in a 3D model of a base body.

### 3

The information processing device according to (2), wherein the 3D avatar generation unit changes the plurality of parts based on an appearance parameter calculated on the basis of at least one of the plurality of impression word scores.

### 4

The information processing device according to (2) or (3), wherein changing the plurality of parts includes moving, deforming, replacing, and adding each of the part.

### 5

The information processing device according to (3) or (4), wherein the appearance parameter indicates a degree of change to each of the part.

### 6

The information processing device according to (3) or (4), wherein the appearance parameter indicates a selection of each of the part.

### 7

The information processing device according to any one of (3) to (6), wherein the 3D avatar generation unit converts the highest impression word score among the plurality of impression word scores into the appearance parameter.

### 8

The information processing device according to any one of (3) to (6), wherein the 3D avatar generation unit converts the impression word score having a numerical value exceeding a threshold value among the plurality of impression word scores into the appearance parameter.

### 9

The information processing device according to any one of (2) to (8), wherein the 3D avatar generation unit has the plurality of 3D models of base bodies, and selects one of the plurality of 3D models of base bodies based on values of the plurality of impression word scores.

### 10

The information processing device according to any one of (3) to (9), wherein the 3D avatar generation unit calculates appearance parameters so that parts making up the 3D avatar do not interfere with each other.

### 11

The information processing device according to any one of (1) to (10), further including a display control unit that controls display of the 3D avatar.

### 12

The information processing device according to (11), wherein the display control unit controls display of information indicating at least one of the plurality of impression word scores used to generate the 3D avatar.

### 13

The information processing device according to (12), wherein the 3D avatar generation unit changes the 3D avatar based on an input for the information from the user.

### 14

An information processing method performed by an information processing device, the method including:
acquiring voice data of a user;
calculating voice features based on a result of analyzing the voice data of the user; and
generating a 3D avatar having an appearance according to at least one of a plurality of impression word scores calculated based on the basis of the voice features.

### 15

A recording medium that records a program causing a computer to perform processing of:
acquiring voice data of a user;
calculating voice features based on a result of analyzing the voice data of the user; and
generating a 3D avatar having an appearance according to at least one of a plurality of impression word scores calculated on the basis of the voice features.

### Reference Signs List

1 Mobile terminal
21 Control unit
22 Imaging unit
23 Microphone
24 Sensor
25 Display
26 Operation unit
27 Speaker
28 Storage unit
29 Communication unit
31 Information processing unit
41 Voice input unit
42 Voice analysis unit
43 Impression word score calculation unit
44 3D avatar generation unit
45 Display control unit
46 Output control unit
51 Computer
52 Server

1. An information processing device comprising:
a voice acquisition unit that acquires voice data of a user;
a voice analysis unit that calculates voice features based on a result of analyzing the voice data of the user; and
a 3D avatar generation unit that generates a 3D avatar having an appearance according to at least one of a plurality of impression word scores calculated on the basis of the voice features.

2. The information processing device according to claim 1, wherein the 3D avatar generation unit generates the 3D avatar by changing a plurality of parts included in a 3D model of a base body.

3. The information processing device according to claim 2, wherein the 3D avatar generation unit changes the plurality of parts based on an appearance parameter calculated on the basis of at least one of the plurality of impression word scores.

4. The information processing device according to claim 3, wherein changing the plurality of parts includes moving, deforming, replacing, and adding each of the part.

5. The information processing device according to claim 3, wherein the appearance parameter indicates a degree of change to each of the part.

6. The information processing device according to claim 3, wherein the appearance parameter indicates a selection of each of the part.

7. The information processing device according to claim 3, wherein the 3D avatar generation unit converts the highest impression word score among the plurality of impression word scores into the appearance parameter.

8. The information processing device according to claim 3, wherein the 3D avatar generation unit converts the impression word score having a numerical value exceeding a threshold value among the plurality of impression word scores into the appearance parameter.

9. The information processing device according to claim 2, wherein the 3D avatar generation unit has the plurality of 3D models of base bodies, and selects one of the plurality of 3D models of base bodies based on values of the plurality of impression word scores.

10. The information processing device according to claim 1, wherein the 3D avatar generation unit calculates appearance parameters so that parts making up the 3D avatar do not interfere with each other.

11. The information processing device according to claim 1, further comprising a display control unit that controls display of the 3D avatar.

12. The information processing device according to claim 11, wherein the display control unit controls display of information indicating at least one of the plurality of impression word scores used to generate the 3D avatar.

13. The information processing device according to claim 12, wherein the 3D avatar generation unit changes the 3D avatar based on an input for the information from the user.

14. An information processing method performed by an information processing device, the method comprising:
acquiring voice data of a user;
calculating voice features based on a result of analyzing the voice data of the user; and
generating a 3D avatar having an appearance according to at least one of a plurality of impression word scores calculated on the basis of the voice features.

15. A recording medium that records a program causing a computer to perform processing of:
acquiring voice data of a user;
calculating voice features based on a result of analyzing the voice data of the user;
and generating a 3D avatar having an appearance according to at least one of a plurality of impression word scores calculated on the basis of the voice features.
